(19) United States
(12) Patent Application Publication
(10) Pub. No.: US 2009/0071755 A1
(43) Pub. Date: Mar. 19, 2009

(54) Pneumatic lubricating system for exerciser

(76) Inventor: Chi-Chang Hsiao, Taichung County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/898,523

(22) Filed: Sep. 13, 2007

(51) Int. Cl. F16N 7/30

(52) U.S. Cl. 184/55.1

(57) ABSTRACT

A pneumatic lubricating system for use in an exercising machine is disclosed to include an oil tank with an oil inlet, an air inlet and an oil outlet, an oil filling pipe connected to the oil inlet for the filling of a lubricating oil into the oil tank, an one-way valve installed in the oil inlet for letting an oil lubricating oil be filled into the oil tank, an air pipe connected to the air inlet, an oil distribution tube with nozzle holes for output of a lubricating oil, an oil pipe connected between the oil outlet and the oil distribution tube, and an air pump for pumping air through the air pipe into the oil tank via the air inlet to force storage lubricating oil out of the oil outlet into the oil distribution tube via the pipe for application.

### BACKGROUND OF THE INVENTION

1. Field of the Invention

The present invention relates to a lubricating system for exerciser and more particularly, to a pneumatic lubricating system for use in an exercising machine to lubricate assigned parts of the exercising machine quantitatively subject to the amount of exercise performed.

2. Description of the Related Art

A treadmill generally comprises a driving roller wheel driven by a treadmill motor to rotate a rotating belt, and pedal members (or rollers) provided at the bottom side of the upper part of the rotating belt to give a support to the rotating belt. Rotating the rotating belt causes friction between the rotating belt and the pedal members. This friction will cause the rotating belt to wear quickly, and will also to increase the load of the motor, shortening the service life of the motor. Therefore, the rotating belt must be lubricated regularly. There are three ways to lubricate the rotating belt as follows:

(1) Lubrication by labor where the user uses a lubrication can to fill a lubricating oil into gaps between the rotating belt and the pedals. This lubricating method is complicated and cannot control the applied amount of the lubricating oil accurately. Excessive amount of the applied lubricating oil will cause a pollution problem. Further, the user may forget to lubricate the exerciser.

(2) Lubrication by oil tank where an oil tank is installed in the exercising machine with an application tube extending to a gap between the pedal members and the rotating belt, and a switch is provided for operation by the user to open the oil tank for letting the lubricating oil be delivered to the lubricating point through the application tube. This method is still not perfect. Because this lubricating method does not provide an extra pressure to force the lubricating oil out of the oil tank to the lubricating point, it is not suitable for the application of a thick lubricating oil having a low flowability. Further, this method cannot control the applied amount accurately.

(3) Lubrication by a felt member where a felt member is mounted on the pedal members to absorb a lubricating oil for lubricating the rotating belt. This method requires a regular supply of the lubricating oil to the felt member. The user may forget to supply the lubricating oil to the felt member. It is difficult to maintain a constant amount of the lubricating oil in the felt member. At the beginning after a supply of the lubricating oil to the felt member, the amount of the lubricating oil in the felt member may be excessively high. A certain period after application, the lubricating oil content in the felt member may be excessively low.

### SUMMARY OF THE INVENTION

The present invention has been accomplished under the circumstances in view. It is the main object of the present invention to provide a pneumatic lubricating system for exerciser, which uses a pneumatic force to supply the lubricating oil to the parts to be lubricated. It is another object of the present invention to provide a pneumatic lubricating system for exerciser, which lubricates the exerciser quantitatively subject to the amount of exercise performed.

To achieve this and other object of the present invention, the pneumatic lubricating system comprises an oil tank sealed with a sealing cap, the oil tank comprising an oil inlet, an air inlet, and an oil outlet; an oil filling pipe connected to the oil inlet for the filling of a lubricating oil into the oil tank; an one-way valve installed in the oil inlet for letting a lubricating oil be filled into the oil tank, an air pipe connected to the air inlet, an oil distribution tube, the oil distribution tube having a plurality of nozzle holes for output of a lubricating oil; an oil pipe connected between the oil outlet and the oil distribution tube; and an air pump adapted to pump air through the air pipe into the oil tank via the air inlet to force storage lubricating oil out of the oil outlet into the oil distribution tube via the pipe.

### BRIEF DESCRIPTION OF THE DRAWINGS

FIG. 1 is a schematic sectional view of a pneumatic lubricating system for exerciser in accordance with the present invention.

FIG. 2 is a schematic sectional side view of a part of a treadmill, showing an application example of the present invention.

FIG. 3 is a schematic sectional view of an alternate form of the pneumatic lubricating system for exerciser in accordance with the present invention.

FIG. 4 is a schematic sectional view of another alternate form of the pneumatic lubricating system for exerciser in accordance with the present invention.

### DETAILED DESCRIPTION OF THE PREFERRED EMBODIMENT

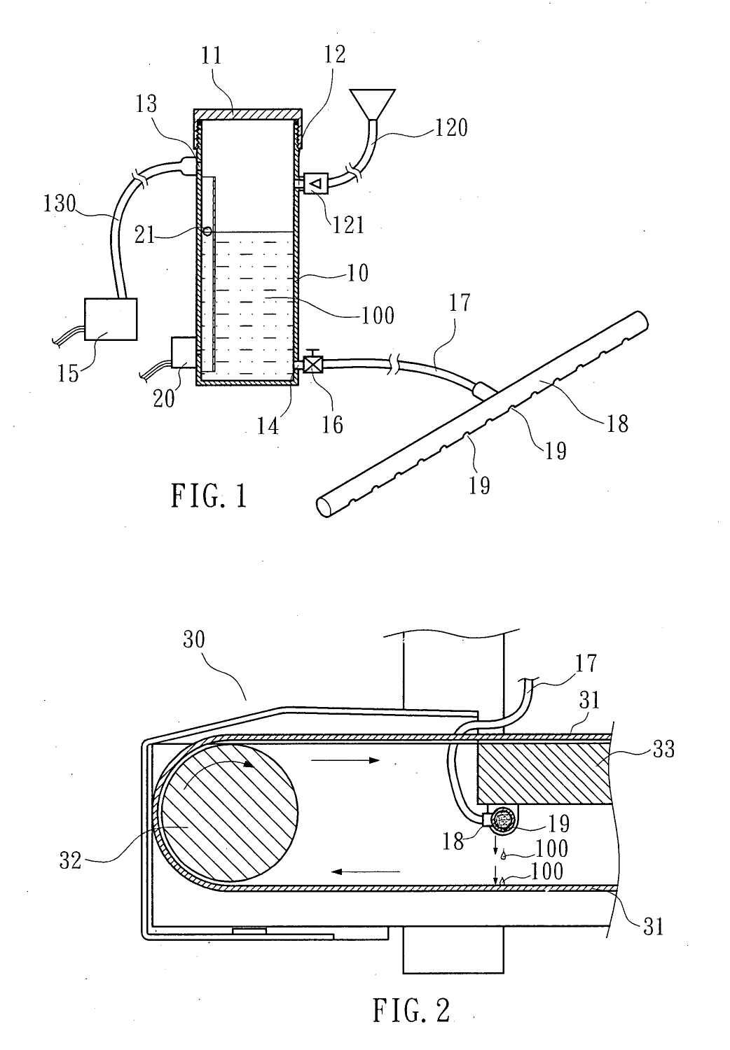

Referring to FIG. 1, a pneumatic lubricating system in accordance with the present invention is shown comprised of an oil tank 10, an air pump 15, an oil distribution tube 18. The oil tank 10 is sealed with a sealing cap 11, having an oil inlet 12, an one-way valve 121 installed in the oil inlet 12, an oil filling pipe 120 connected to the oil inlet 12 for the filling of a lubricating oil 100 into the oil tank 10 through the one-way valve 121, an air inlet 13, an air pipe 130 connected to the air inlet 13, and an oil outlet 14. An oil pipe 17 is connected between the oil outlet 14 and the oil distribution tube 18. The air pump 15 is adapted to pump air through the air pipe 130 into the oil tank 10 via the air inlet 13 to force the lubricating oil 100 out of the oil outlet 14 into the oil distribution tube 18 via the oil pipe 17. The oil distribution tube 18 has a plurality of nozzle holes 19 for output of the lubricating oil 100. Further, an electromagnetic valve 16 is installed in the connection between the oil outlet 14 and the oil pipe 17, and controlled to close/open the oil passage between the connection between the oil outlet 14 and the oil pipe 17. A float 21 is floating on the lubricating oil 100 in the oil tank 10. A sensor 20 is mounted on the outside of the oil tank 10 and adapted to detect the elevation of the float 21, i.e., the elevation of the lubricating oil 100 in the oil tank 10. When the elevation of the lubricating oil 100 in the oil tank 10 dropped below a predetermined low level, the user immediately knows the situation from the indication of the sensor 20.

FIG. 2 shows the pneumatic lubricating system used in a treadmill 30. The treadmill 30 comprises a driving roller wheel 32 driven by a treadmill motor (not shown) to rotate a rotating belt 31, and pedal members (or rollers) 33 at the bottom side of the upper part of the rotating belt 31. The oil distribution tube 18 of the pneumatic lubricating system of the present invention is affixed to the pedal members 33. The oil pipe 17 and the air pump 15 are affixed to the frame structure of the treadmill 30 at suitable locations.

When the air pump 15 is started subject to the setting, it pumps air into the oil tank 10 to force the lubricating oil 100 out of the oil tank 10 through the oil outlet 14, and at the same time the electromagnetic valve 16 is opened to let the lubrication oil 100 be delivered through the oil pipe 17 into the oil distribution tube 18 and then forced out of the nozzle holes 19 to lubricate the rotating belt 31, reducing friction between the rotating belt 31 and the pedal members 33.

The power input end of the air pump 15 is electrically connected to the mileage controller of the treadmill 30, so that the air pump 15 is started to pump air into the oil tank 10 when each operation of the treadmill reaches a predetermined mileage, and stopped from operation a predetermined length of time after start, i.e., the lubricating oil 100 is applied to the rotating belt 31 when the rotation of the rotating belt 31 reached a set value. Therefore, the more the amount of exercise is the more the applied amount of the lubricating oil 100 will be. The invention achieves quantitative application of the lubricating oil 100 subject to the amount of exercise performed.

The one-way valve 121 in the oil filling pipe 120 allows the user to fill the lubricating oil 100 into the oil tank 10 directly. Because of the effect of the one-way valve 121, pumping of the air pump 15 does not cause leakage of air. The electromagnetic valve 16 is for safety purpose. When the sealing cap 11 of the oil tank 10 is not in an airtight status, closing of the electromagnetic valve 16 prevents oil leakage. Further, an alarm may be electrically connected to the sensor 20 and adapted to give an audio warning signal when the lubricating oil 100 in the oil tank 10 dropped below a predetermined low level.

The pneumatic lubricating system may be variously embodied without departing from the spirit and scope of the invention. Certain alternate forms of the present invention are as follows:

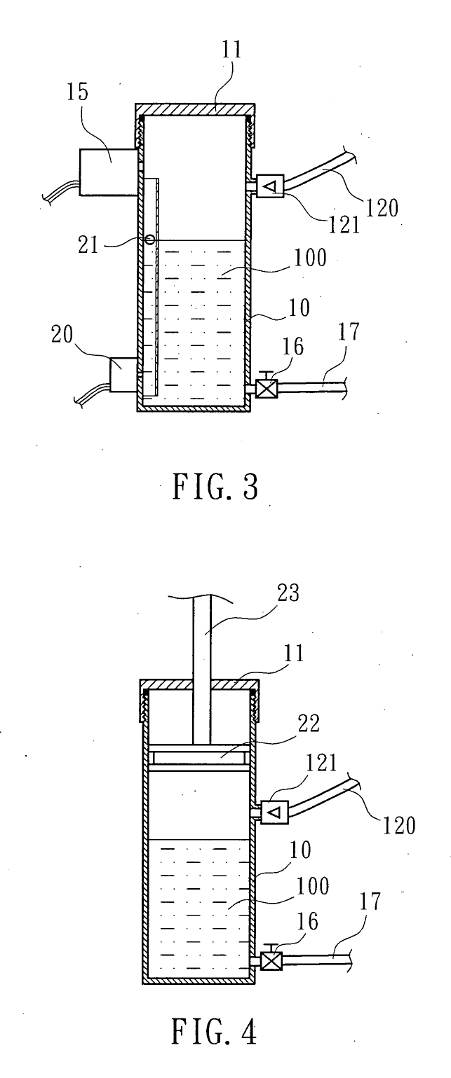

1. As shown in FIG. 3, the air pump 15 can be formed integral with a part (the shell or sealing cap) of the oil tank 10.

2. As shown in FIG. 4, a piston 22 is mounted in the oil tank 10, and a piston rod 23 is perpendicularly connected to the center of the piston 22 and extending out of the sealing cap 11 of the oil tank 10 for reciprocating the piston 22 to pump air and to force the lubricating oil 100 out of the oil tank 10 for application.

3. The sensor 20 that is used to detect the level of the lubricating oil 100 in the oil tank 10 can be an infrared sensor or a metal probe.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A pneumatic lubricating system comprising:
an oil tank sealed with a sealing cap, said oil tank comprising an oil inlet, an air inlet, and an oil outlet;
an oil filling pipe connected to said oil inlet for the filling of a lubricating oil into said oil tank;
an one-way valve installed in said oil inlet for letting an oil lubricating oil be filled into said oil tank,
an air pipe connected to said air inlet,
an oil distribution tube, said oil distribution tube having a plurality of nozzle holes for output of a lubricating oil;
an oil pipe connected between said oil outlet and said oil distribution tube; and
an air pump adapted to pump air through said air pipe into said oil tank via said air inlet to force storage lubricating oil out of said oil outlet into said oil distribution tube via said oil pipe.

2. The pneumatic lubricating system as claimed in claim 1, further comprising an electromagnetic valve installed in between said oil outlet and said oil pipe, and controlled to close/open said oil outlet.

3. The pneumatic lubricating system as claimed in claim 1, further comprising sensor means adapted to detect the level of the lubricating oil stored in said oil tank.
